(19) United States
(12) Patent Application Publication
(10) Pub. No.: US 2011/0017005 A1
(43) Pub. Date: Jan. 27, 2011

(54) REDUCED FRICTION RING AND PINION GEAR SET

(75) Inventors: Jonathan D. Batdorff, Fort Wayne, IN (US); James J. Korson, Fort Wayne, IN (US)

Correspondence Address: International Truck Intellectual Property Company,, 4201 WINFIELD ROAD, WARRENVILLE, IL, 60555, US

(73) Assignee: International Truck Intellectual Property Company, LLC, Warrenville, IL (US)

(21) Appl. No.: 12/507,439

(22) Filed: Jul. 22, 2009

(51) Int. Cl. F16H 1/18

(52) U.S. Cl. 74/424.5

(57) ABSTRACT

A ring and pinion gear set comprises a ring gear and a pinion gear. The pinion gear has a plurality of rolling elements. The ring gear has a plurality of mating grooves. The plurality of rolling elements of the pinion gear is adapted to interact with the plurality of mating grooves of the ring gear.

### TECHNICAL FIELD

This disclosure relates to a ring and pinion gear set design, such as for a vehicle, and more particularly to a reduced friction ring and pinion gear design that utilizes rolling element bearings in the pinion gear.

### BACKGROUND

Many vehicles utilize a ring and pinion gear set in order to transfer power from a transmission of a vehicle into axles of the vehicle in order to drive wheels of the vehicle. As shown in FIG. 1, an existing ring and piston gear design 10 is shown that comprises a pinion gear 12 and a ring gear 14. The pinion gear 12 has a first plurality of teeth 16, while the ring gear 14 has a second plurality of teeth 18. The first plurality of teeth 16 are adapted to mesh with the second plurality of teeth 18 to transfer torque from the pinion gear 12 to the ring gear 14. In order to obtain proper meshing of the first and second plurality of teeth 16, 18, great precision is required in the manufacturing of both the pinion gear 12 and the ring gear 14. This makes machining the pinion gear 12 and the ring gear 14 difficult, as tight tolerances are required. In addition to manufacturing difficulties, alignment of the pinion gear teeth 16 and the ring gear teeth 18 must precisely match in order to minimize noise and friction from the meshing of the pinion gear 12 and the ring gear 14. Additionally, as contours of the first plurality of teeth 16 and the second plurality of teeth 18 are sliding past each other as the teeth 16, 18 engage and disengage to transmit torque, high frictional forces are formed that cause inefficiency, resulting in a reduction of vehicle fuel economy.

Therefore, a need exists for a ring and pinion gear set that reduces friction at the interface between a pinion gear and a ring gear and easies the ability to obtain proper gear mesh between the pinion gear and the ring gear.

### SUMMARY

Discussed herein are a number of embodiments of a ring and pinion gear set. According to one embodiment, a ring and pinion gear set comprises a ring gear and a pinion gear. The pinion gear has a plurality of rolling elements. The plurality of rolling elements is disposed about at least a portion of a periphery of the pinion gear. The ring gear has a plurality of mating grooves. The plurality of rolling elements of the pinion gear is engageable with the plurality of mating grooves of the ring gear.

According to another embodiment, a ring and pinion gear set comprises a pinion gear and a ring gear. The pinion gear has a plurality of rolling elements. The plurality of rolling elements is disposed about at least a portion of a periphery of the pinion gear. Each of the plurality of rolling elements has a cage portion and a plurality of ball bearings secured by the cage portion. The ring gear has a plurality of mating grooves. The mating grooves have a complimentary shape relative to the ball bearings. The ball bearings of the rolling elements of the pinion gear are engageable with the mating grooves of the ring gear to transfer torque from the pinion gear to the ring gear.

According to a further embodiment, a pinion gear for a reduced friction ring and pinion gear set comprises a plurality of rolling elements. Each of the plurality of rolling elements has a cage portion and a plurality of ball bearings. The plurality of ball bearings is retained within the cage portion. The cage portion is joined to the pinion gear. The ball bearings of the rolling elements of the pinion gear are engageable with a plurality of corresponding mating grooves of the ring gear to transfer torque from the pinion gear to the ring gear.

### BRIEF DESCRIPTION OF THE DRAWINGS

FIG. 1 is side view of a prior art ring and pinion gear set;

FIG. 2 is a side view of one embodiment of a ring and pinion gear set; and

FIG. 3 is a detailed side view of a portion of pinion gear of the ring and pinion gear set of FIG. 2.

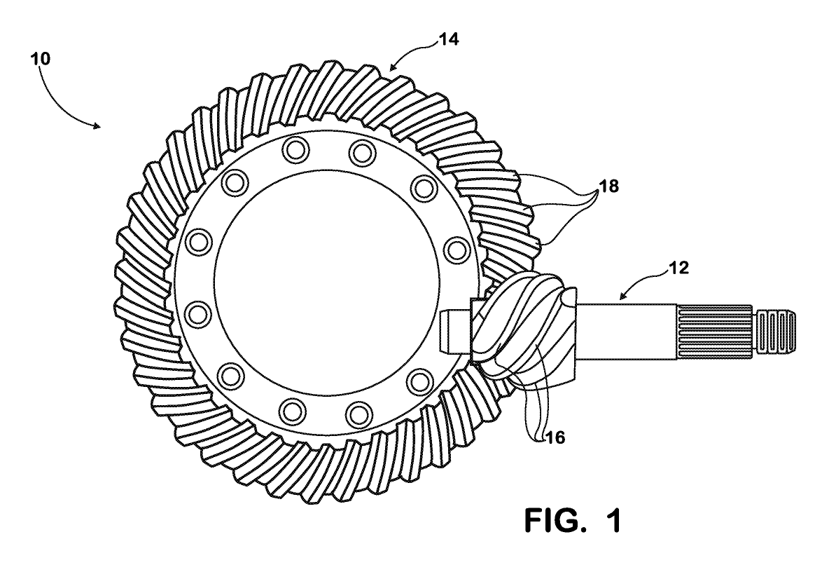

### DETAILED DESCRIPTION

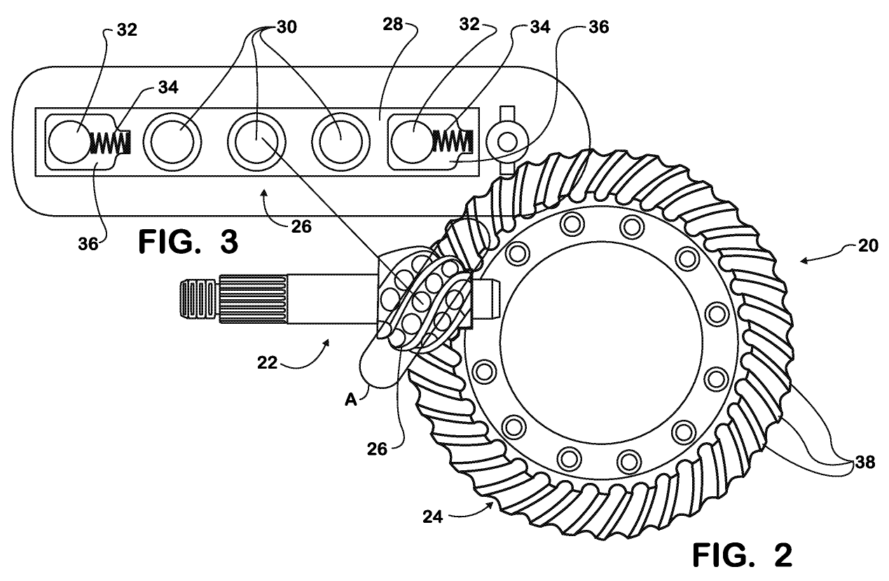

FIG. 2 shows a side view of a ring and pinion gear set 20 according to one embodiment. The ring and pinion gear set 20 comprises a pinion gear 22 and a ring gear 24. The pinion gear 22 comprises a plurality of rolling elements 26. The rolling elements 26 are disposed about at least a portion of the periphery of the pinion gear 22. A detailed view of region A of FIG. 2, showing one of the rolling elements 26, is depicted in FIG. 3. As shown in FIG. 3, each of the rolling elements 26 comprises a cage portion 28 that is adapted to hold a plurality of stationary ball bearings 30, as well as moveable end ball bearings 32. The moveable end ball bearings 32 are positioned within the cage portion 28 by a spring 34. The spring 34 is adapted to bias the movable end ball bearing 32 within a slot 36 of the cage portion 28 toward a leading edge of the cage portion 28 as the pinion gear 22 rotates.

While the rolling element 26 is depicted as being generally flat in FIG. 3, it is contemplated that the rolling element 26 will have a generally helical shape. It is additionally contemplated that cage portion 28 may be joined, such as by resistance welding in one embodiment, to the pinion gear 22 to form the rolling element 26.

Turning back to FIG. 2, the ring gear 24 comprises a plurality of mating grooves 38. The mating grooves 38 are adapted to receive the ball bearings 30, 32 of the rolling elements 26 of the pinion gear 22. The mating grooves 38 have a complimentary shape relative to the ball bearings 30, 32. That is, the mating grooves 38 are generally semi-circular when the ball bearings 30, 32 are generally spherical. The contact between the ball bearings 30, 32 and the mating grooves 38 allows torque to be transferred from the pinion gear 22 to the ring gear 24. The use of ball bearings 30, 32 to transfer torque from the pinion gear 22 to the ring gear 24 reduces the friction between the pinion gear 22 and the ring gear 24 compared to a traditional ring and pinion gear set 10. This reduction in friction will result in increased fuel economy for a vehicle utilizing the ring and pinion gear set 20.

The slots 36 of the cage portion 28 of the pinion gear 22 allows the end ball bearings 32 to gradually transition into the mating groove 38 of the ring gear 24. The movement of the end ball bearings 32 additionally improves the alignment of the pinion gear 22 with the ring gear 24. Thus, the end ball bearings 32 of the pinion gear 22 are self-aligning with the mating groove 38 of the ring gear 24. This self-aligning aspect of the contact between the pinion gear 22 and the ring gear 24 allows for larger tolerances in the manufacturing and the assembly of ring and pinion gear set 20.

As contact between the pinion gear 22 and the ring gear 24 is a rolling contact between the bearings 30, 32 of the pinion gear 22 and the mating grooves 38 of the ring gear 24, noise of the ring and pinion gear set 20 is reduced compared to a traditional ring and pinion gear set 10. The reduction in noise may be attributed to a mating surface contact between the bearings 30, 32 and the mating grooves 38 of the ring and pinion gear set 20 compared to the teeth 16, 18 of the ring and pinion gear set 10. The slot 36 allows the end bearings 32 to gradually transition into the mating grooves 38, thereby reducing the noise of the ring and pinion gear set 20.

Additionally, the bearing 30, 32 contacting the mating grooves 38 reduces the susceptibility of damage to either the pinion gear 22 or the ring gear 24 of the ring and pinion gear set 20. The susceptibility of damage is reduced due to the gradual transition of the bearings 30, 32 into the mating grooves 38.

What is claimed is:

1. A ring and pinion gear set comprising:
a pinion gear having a plurality of rolling elements disposed about at least a portion of a periphery of the pinion gear; and
a ring gear having a plurality of mating grooves, wherein the plurality of rolling elements of the pinion gear are engageable with the plurality of mating grooves of the ring gear.

2. The ring and pinion gear set of claim 1, wherein at least one of the plurality of rolling elements of the pinion gear comprises a cage portion and a plurality of stationary bearings.

3. The ring and pinion gear set of claim 2, wherein at least one of the plurality of rolling elements further comprises at least one moveable ball bearing secured by the cage portion.

4. The ring and pinion gear set of claim 3, wherein the plurality of rolling elements further comprises a slot, the slot being configured to receive the at least one movable ball bearing.

5. The ring and pinion gear set of claim 4, wherein the plurality of rolling elements further comprises a spring disposed in the slot and being in contact with the at least one moveable ball bearing, the spring provided for biasing the at least one moveable ball bearing within the slot.

6. The ring and pinion gear set of claim 2, wherein the mating grooves of the ring gear have a complimentary shape relative to the plurality of stationary ball bearings.

7. A ring and pinion gear set comprising:
a pinion gear having a plurality of rolling elements disposed about at least a portion of a periphery of the pinion gear, each of the plurality of rolling elements having a cage portion and a plurality of ball bearings secured by the cage portion; and
a ring gear having a plurality of mating grooves, each of the plurality of mating grooves having a complimentary shape relative to each of the plurality of ball bearings, wherein each of the plurality of ball bearings of the plurality of rolling elements of the pinion gear is engageable with the plurality of mating grooves of the ring gear.

8. The ring and pinion gear set of claim 7, wherein each of the plurality of ball bearings is generally spherical.

9. The ring and pinion gear set of claim 8, wherein each of the plurality of mating grooves is generally semi-circular.

10. The ring and pinion gear set of claim 7, wherein the plurality of rolling elements define a generally helical shape about at least a portion of the periphery of the pinion gear.

11. The ring and pinion gear set of claim 7, wherein the plurality of ball bearings comprises a plurality of stationary ball bearings and at least one moveable ball bearing.

12. The ring and pinion gear set of claim 11, wherein the at least one moveable ball bearing is located proximate a first end of the plurality of rolling elements.

13. The ring and pinion gear set of claim 12, wherein the plurality of ball bearings comprises at least a second moveable ball bearing located proximate a second end of the plurality of rolling elements.

14. The ring and pinion gear set of claim 7, wherein the plurality of ball bearings is retained within the cage portion.

15. A reduced friction ring and pinion gear set comprising:
a pinion gear having a plurality of rolling elements, each of the plurality of rolling elements having a cage portion and a plurality of ball bearings, the plurality of ball bearings retained within the cage portion, and the cage portion joined to the pinion gear, wherein each of the plurality of ball bearings of each of the plurality of rolling elements of the pinion gear are engageable with a plurality of corresponding mating grooves of a ring gear to transfer torque from the pinion gear to the ring gear.

16. The pinion gear of claim 15, wherein each of the plurality of ball bearings are generally spherical.

17. The pinion gear of claim 15, wherein the plurality of ball bearings includes a plurality of stationary ball bearings.

18. The pinion gear of claim 17, wherein the plurality of ball bearings includes at least one moveable ball bearing.

19. The pinion gear of claim 15, wherein the cage portion is resistance welded to the pinion gear
